(19) United States
(12) Patent Application Publication
(10) Pub. No.: US 2008/0152784 A1
(43) Pub. Date: Jun. 26, 2008

(54) METHODS OF MANUFACTURING COATINGS AND COATED MEDICAL DEVICES

(75) Inventor: Eric B. Stenzel, County Galway (IE)

Correspondence Address: KENYON & KENYON LLP, 1500 K STREET N.W., SUITE 700, WASHINGTON, DC, 20005, US

(73) Assignee: BOSTON SCIENTIFIC SCIMED, INC., Maple Grove, MN (US)

(21) Appl. No.: 11/945,406

(22) Filed: Nov. 27, 2007

Related U.S. Application Data
(60) Provisional application No. 60/876,504, filed on Dec. 22, 2006.

(51) Int. Cl. B05D 1/02

(52) U.S. Cl. 427/2.25

(57) ABSTRACT

Methods of manufacturing porous coatings and medical devices having porous coatings are provided. In embodiments of the invention, an inert additive, a therapeutic agent, and a polymer are applied to the body of a medical device to form a coating. The therapeutic agent and the polymer are insoluble in the inert additive. After drying the coating, the inert additive may be removed to form pores.

### RELATED APPLICATIONS

This application claims benefit of U.S. Provisional Application No. 60/876,504, filed Dec. 22, 2006, which is incorporated herein in its entirety.

### TECHNICAL FIELD

The present invention relates to various methods of manufacturing porous coatings and coated medical devices.

### BACKGROUND

Diffusional release of drug particles from a polymer matrix, such as a polymer coating on a medical device like a stent, is an important and commonly used method of achieving controlled drug release. The release of drug particles from a polymer matrix is thought to occur through a network of pores, which may be created by the drug particles that are initially loaded in the matrix. In particular, an aqueous medium may imbibe into the matrix and dissolve the drug particles. The drug particles, once dissolved, leave behind pores in the polymer matrix and the remaining drug may elute through these pores. Such a release mechanism, however, may be affected by particle size and loading. Specifically, drug particles may not touch each other when the drug loading is low or when the drug particles are small. Thus, with low loading or small particle size, many drug particles may be completely surrounded by polymer resulting in the drug particles being trapped in the polymer. Therefore, only those drug particles on or having a path to the surface of the matrix may be able to be released.

One method of forming a porous polymer without relying on the drug particles to create the pores is by cross-linking linear chains of monomers, such as styrene and divinylbenzene, to create very small pores within the polymer. Cross-linking, however, may have to be reduced to increase pore size. Such reduction in cross-linking may decrease the physical stability of the polymer such that the polymers cannot withstand much pressure before collapsing.

Another method of forming a porous polymer is using leachable additives to create the pores in the polymers. Leaching, however, is considered an undesirable attribute since leaching cannot be controlled and may continue after the device containing the porous polymer is deployed into the body.

Another method of forming a porous polymer where the pores are formed independent of cross-linking is to polymerize monomers in the presence of porogens, which are soluble in monomers but insoluble in formed polymers. As polymerization proceeds, pores are formed in the spaces where porogens are found. Porogens, however, may plasticize the surrounding polymer and can leach into the body thereby raising biocompatibility and toxicity concerns.

Yet another method of forming a porous polymer involves polymerizing monomers as the continuous phase in a high internal phase emulsion or foam to form cross-linked homogenous porous polymers. Emulsions and foams, however, may be hard to control and the emulsion and foaming agents may need to be in small quantities in order to maintain integrity.

Therefore, there is a need in the art for another method of manufacturing a porous coating, such as for a medical device.

### SUMMARY OF THE INVENTION

Methods of manufacturing porous coatings and medical devices having porous coatings are provided. In certain embodiments of the present invention, an inert additive, a therapeutic agent, and a polymer are applied to the body of a medical device to form a coating. The therapeutic agent and the polymer are insoluble in the inert additive. When the coating is dried to remove the inert additive, pores may be formed in regions from which the inert additive is removed. In some embodiments, channels or fissures may be formed in the coating. The inert additive, therapeutic agent, and polymer can be applied to the body of a medical device in various different ways. Pores and/or channels in a coating can provide a pathway in the coating that allows the therapeutic agent therein access to the medium to which the medical device is exposed. Such access allows the therapeutic agent to elute out of the polymer and prevents or decreases the amount of therapeutic agent that is isolated or trapped within the polymer.

In certain embodiments, a porous coating is manufactured by forming a coating comprising an inert additive, a therapeutic agent, and a polymer, where the therapeutic agent and the polymer are insoluble in the inert additive. The coating may then be dried to remove the inert additive. Pores may be formed in regions from which the inert additive is removed.

### BRIEF DESCRIPTION OF THE DRAWINGS

FIG. 1 shows a method of creating a coating according to an embodiment of the present invention.

FIG. 2 shows a method of creating a coating according to another embodiment of the present invention.

FIG. 3 shows a method of creating a coating according to another embodiment of the present invention.

FIG. 4 shows a method of creating a coating according to another embodiment of the present invention.

### DETAILED DESCRIPTION OF THE INVENTION

The present invention provides methods of manufacturing porous coatings and medical devices having a porous coating. The porous coatings comprise a polymer and a therapeutic agent that are insoluble in a common substance. That is, for a given combination of a therapeutic agent and a polymer, a substance may be chosen in which neither the therapeutic agent nor the polymer is soluble. As used herein, such a substance may be referred to as an “inert additive.” The phrase “inert additive” is not intended to imply that the substance is chemically inert in any way other than that it does not dissolve the specific therapeutic agent and polymer materials with which it is used.

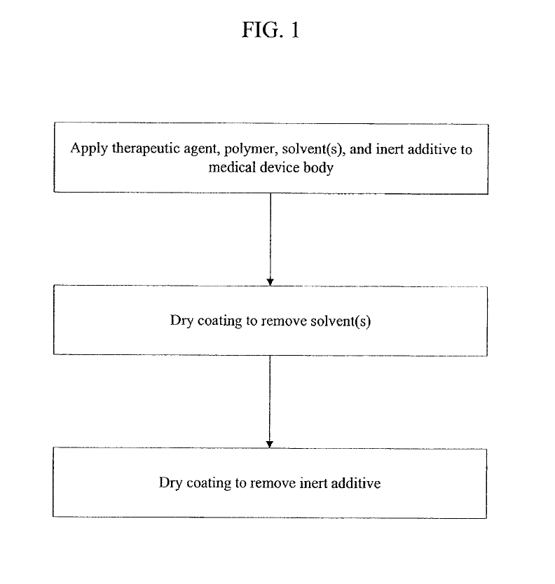

In certain embodiments of the invention, an inert additive, a therapeutic agent that is insoluble in the inert additive, and a polymer that is insoluble in the inert additive are deposited on the body of a medical device, such as a stent, to form a coating. The inert additive is subsequently removed from the coating to form pores in the coating. The therapeutic agent, inert additive and polymer can be deposited on the body of the medical device in a number of different ways and the inert additive can be removed at various stages of the application process. In certain embodiments, the therapeutic agent, the polymer, and the inert additive can be applied to the medical device simultaneously. For example, referring to FIG. 1, in certain embodiments a mixture of a therapeutic agent, a polymer, at least one solvent, and an inert additive is applied to the body of the medical device. The at least one solvent may be a single solvent in which both the polymer and the therapeutic agent are soluble, or it may be a combination of at least two solvents, where one solvent dissolves the polymer and the other solvent dissolves the therapeutic agent. After application of the mixture, the at least one solvent can be removed to form a coating. Since both the therapeutic agent and the polymer are insoluble in the inert additive, pockets of the inert additive may remain within the polymer coating. Subsequently, the inert additive can be removed from the coating to form pores in the regions of the polymer coating previously occupied by the inert additive. The term “pores” is used herein to include holes, channels, fissures, and the like. The pores provide pathways to enable elution of more therapeutic agent from the coating.

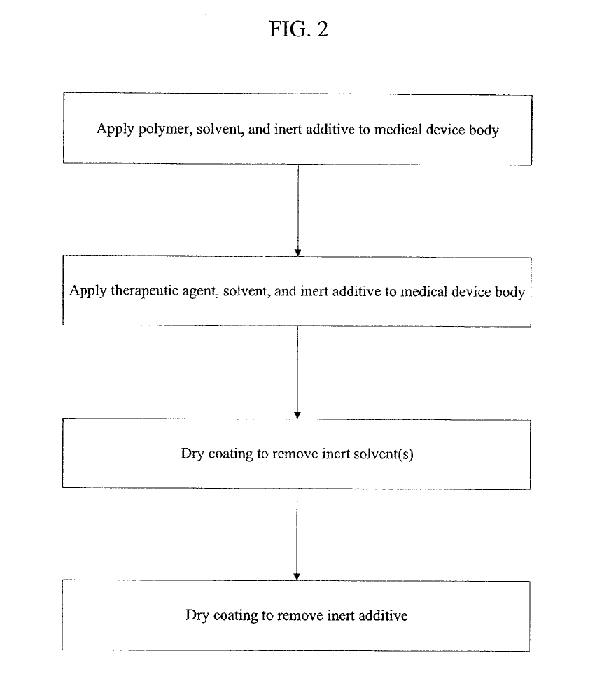

In other embodiments, the therapeutic agent, the polymer, and the inert additive can be applied to the body of the medical device in multiple steps. For example, referring to FIG. 2, in certain embodiments, a first mixture comprising a polymer, a first solvent, and an inert additive may be applied to the body of a medical device. Then, a second mixture comprising a therapeutic agent and a second solvent may be applied to the body of the medical device. The second mixture can also comprise an inert additive. The first and second solvent, which can be the same or different, may then be removed to form a polymer coating. In embodiments where the inert additive is only added to the first mixture, pockets of the inert additive may remain closer to the outer surface of the body of the medical device than the outer surface of the coating. Depending on the solvents, the first and second solvents may be removed simultaneously or sequentially. Subsequently, the inert additive is removed from the coating, leaving pores.

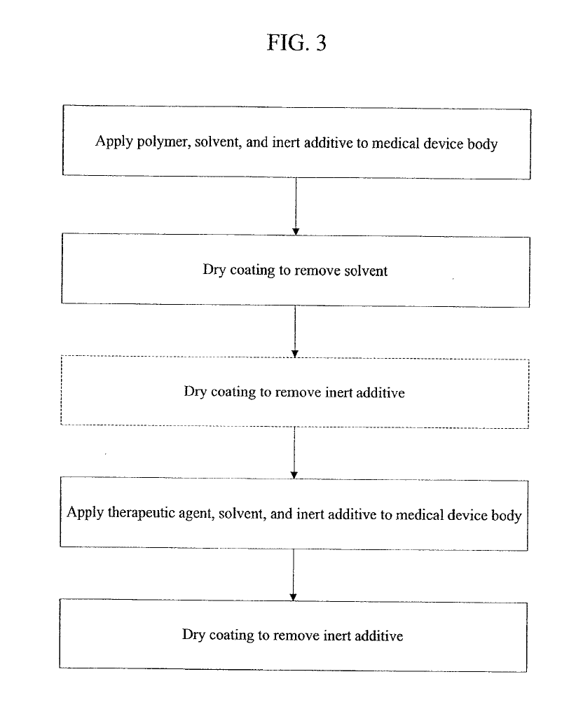

Referring to FIG. 3, in other embodiments, a polymer may be applied to the body of a medical device and then a mixture comprising a therapeutic agent and an inert additive may be applied to the body of the medical device. Various methods as discussed herein may be used to deposit the polymer and the mixture. In an embodiment, the therapeutic agent is soluble in the same solvent used to apply the polymer. The polymer may be applied in a dissolved form, and the solvent removed to form a polymer coating. The therapeutic agent may then be applied in a mixture including the same solvent, causing the pre-deposited polymer to soften. That is, the solvent in the therapeutic agent mixture may dissolve the pre-deposited polymer or portions of the pre-deposited polymer. The therapeutic agent, inert additive, or both may then mix with the previously deposited polymer. The polymer mixture may be deposited before the therapeutic agent, or the therapeutic agent mixture may be deposited before the polymer. Each mixture may include the inert additive, but at least one of the mixtures should include the inert additive to allow for the formation of pores.

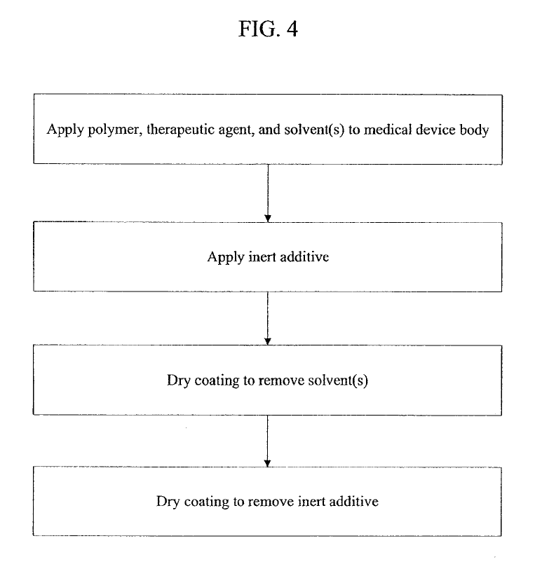

Referring to FIG. 4, in other embodiments, a mixture comprising a polymer, a therapeutic agent, and a solvent is applied to the medical device and then an inert additive is added. The solvent can then be removed to form a polymer coating followed by removal of the inert additive to form pores in the polymer coating.

The above-described methods of forming a porous coating are only exemplary and other sequences of steps may also be performed to manufacture a porous coating.

The various components of the coatings can be applied to the body of the medical device by various methods. For example, the components of the coatings can be applied by any known suitable method in the art including dipping, spraying, rolling, brushing, electrostatic plating or spinning, vapor deposition, air spraying including atomized spray coating, and spray coating using an ultrasonic nozzle.

The solvents and inert additives may be removed from the mixture or mixtures by any suitable mechanism known in the art, including drying. For example, the body of the medical device may be heated to a temperature above the boiling point of the solvent or inert additive, causing the solvent or inert additive to evaporate out of the polymer. As another example, the body of the medical device may be placed in a vacuum, causing the solvent or inert additive to evaporate out of the polymer. Combinations of effects may be used, such as heating while applying pressure or a vacuum.

In other embodiments, the inert additive may be a particulate, magnetic material. The inert additive and a polymer dissolved in a solvent may be applied to the medical device together or separately. The polymer may then be dried to form a coating. A magnetic field may then be applied to or around the medical device to attract the particulate inert additive out of the coating, causing pores to be formed in the coating. Some solvent may be left in the coating prior to removal of the inert additive to assist removal of the inert additive by only partially drying the coating prior to removal of the inert additive. In such a process, the coating may be dried completely after removal of the inert additive.

Various combinations of inert additives, and polymers and therapeutic agents that are insoluble in the inert additives may be used in accordance with embodiments of the present invention. For example, in certain embodiments, the inert additive is water and the therapeutic agent and polymer are water-insoluble. For example, the water-insoluble therapeutic agent can be anti-inflammatory agents such as dexamethasone, prednisolone, corticosterone, budesonide, estrogen, sulfasalazine, mesalamine, and analogues thereof; antineoplastic/antiproliferative/anti-miotic agents such as paclitaxel, 5-fluorouracil, cisplatin, vinblastine, vincristine, epothilones, endostatin, angiostatin, thymidine kinase inhibitors, and analogues thereof; anesthetic agents such as lidocaine, bupivacaine, ropivacaine, and analogues thereof; anti-coagulants; and growth factors. Non-limiting examples of a water-insoluble polymer include cellulose derivatives (e.g. ethylcellulose), polyvinyl acetate (KOLLICOAT SR30D from BASF), copolymers based on ethyl acrylate and methylmethacrylate, copolymers of acrylic and methacrylic acid esters with quaternary ammonium groups, such as Eudragit NE, RS or RS30D, RL or RL30D and the like.

In other embodiments, the inert additive is an organic liquid and the therapeutic agent and polymer are insoluble in the organic liquid.

The polymer/solvent/therapeutic agent mixture may be a dispersion, suspension or a solution. The therapeutic agent may also be mixed with the polymer in the absence of a solvent. The therapeutic agent may be dissolved in the polymer/solvent mixture or in the polymer to be in a true solution with the mixture or polymer, dispersed into fine or micronized particles in the mixture or polymer, suspended in the mixture or polymer based on its solubility profile, or combined with micelle-forming compounds such as surfactants or adsorbed onto small carrier particles to create a suspension in the mixture or polymer. Mixtures used in embodiments of the present invention may comprise multiple polymers and/or multiple therapeutic agents. Multiple solvents may be used to dissolve the polymer and/or the therapeutic agent. The solvents referred to herein may also comprise multiple or multi-part solvents.

Therapeutic agents may be selected in conjunction with polymers, solvents, and inert additives, such that the therapeutic agent, the polymer, or both are insoluble in the inert additive. Various different therapeutic agents may be used with the present invention and may be selected from a number of drug types depending on the desired application. For example, the therapeutic agent can be a non-genetic therapeutic agent, a biomolecule, a small molecule, or cells.

Exemplary non-genetic therapeutic agents include anti-thrombogenic agents such heparin, heparin derivatives, prostaglandin (including micellar prostaglandin E1), urokinase, and PPack (dextrophenylalanine proline arginine chloromethylketone); anti-proliferative agents such as enoxaparin, angiopeptin, sirolimus (rapamycin), tacrolimus, everolimus, zotarolimus, monoclonal antibodies capable of blocking smooth muscle cell proliferation, hirudin, and acetylsalicylic acid; anti-inflammatory agents such as dexamethasone, rosiglitazone, prednisolone, corticosterone, budesonide, estrogen, estrodiol, sulfasalazine, acetylsalicylic acid, mycophenolic acid, and mesalamine; anti-neoplastic/anti-proliferative/anti-mitotic agents such as paclitaxel, epothilone, cladribine, 5-fluorouracil, methotrexate, doxorubicin, daunorubicin, cyclosporine, cisplatin, vinblastine, vincristine, epothilones, endostatin, trapidil, halofuginone, and angiostatin; anti-cancer agents such as antisense inhibitors of c-myc oncogene; anti-microbial agents such as triclosan, cephalosporins, aminoglycosides, nitrofurantoin, silver ions, compounds, or salts; biofilm synthesis inhibitors such as non-steroidal anti-inflammatory agents and chelating agents such as ethylenediaminetetraacetic acid, O,O′-bis(2-aminoethyl) ethyleneglycol-N,N,N′,N′-tetraacetic acid and mixtures thereof; antibiotics such as gentamycin, rifampin, minocyclin, and ciprofloxacin; antibodies including chimeric antibodies and antibody fragments; anesthetic agents such as lidocaine, bupivacaine, and ropivacaine; nitric oxide; nitric oxide (NO) donors such as linsidomine, molsidomine, L-arginine, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, warfarin sodium, Dicumarol, aspirin, prostaglandin inhibitors, platelet aggregation inhibitors such as cilostazol and tick antiplatelet factors; vascular cell growth promotors such as growth factors, transcriptional activators, and translational promotors; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; agents which interfere with endogenous vascoactive mechanisms; inhibitors of heat shock proteins such as geldanamycin; angiotensin converting enzyme (ACE) inhibitors; beta-blockers; βAR kinase (βARK) inhibitors; phospholamban inhibitors; protein-bound particle drugs such as ABRAXANE™; and any combinations and prodrugs of the above.

Exemplary biomolecules include peptides, polypeptides and proteins; oligonucleotides; nucleic acids such as double or single stranded DNA (including naked and cDNA), RNA, antisense nucleic acids such as antisense DNA and RNA, small interfering RNA (siRNA), and ribozymes; genes; carbohydrates; angiogenic factors including growth factors; cell cycle inhibitors; and anti-restenosis agents. Nucleic acids may be incorporated into delivery systems such as, for example, vectors (including viral vectors), plasmids or liposomes.

Non-limiting examples of proteins include serca-2 protein, monocyte chemoattractant proteins (MCP-1) and bone morphogenic proteins (“BMP's”), such as, for example, BMP-2, BMP-3, BMP-4, BMP-5, BMP-6 (VGR-1), BMP-7 (OP-1), BMP-8, BMP-9, BMP-10, BMP-11, BMP-12, BMP-13, BMP-14, BMP-15. Preferred BMP's are any of BMP-2, BMP-3, BMP-4, BMP-5, BMP-6, and BMP-7. These BMPs can be provided as homodimers, heterodimers, or combinations thereof, alone or together with other molecules. Alternatively, or in addition, molecules capable of inducing an upstream or downstream effect of a BMP can be provided. Such molecules include any of the “hedghog” proteins, or the DNA's encoding them. Non-limiting examples of genes include survival genes that protect against cell death, such as anti-apoptotic Bcl-2 family factors and Akt kinase; serca 2 gene; and combinations thereof. Non-limiting examples of angiogenic factors include acidic and basic fibroblast growth factors, vascular endothelial growth factor, epidermal growth factor, transforming growth factors α and β, platelet-derived endothelial growth factor, platelet-derived growth factor, tumor necrosis factor α, hepatocyte growth factor, and insulin-like growth factor. A non-limiting example of a cell cycle inhibitor is a cathespin D (CD) inhibitor. Non-limiting examples of anti-restenosis agents include p15, p16, p18, p19, p21, p27, p53, p57, Rb, nFkB and E2F decoys, thymidine kinase and combinations thereof and other agents useful for interfering with cell proliferation.

Exemplary small molecules include hormones, nucleotides, amino acids, sugars, and lipids and compounds have a molecular weight of less than 100 kD.

Exemplary cells include stem cells, progenitor cells, endothelial cells, adult cardiomyocytes, and smooth muscle cells. Cells can be of human origin (autologous or allogenic) or from an animal source (xenogenic), or genetically engineered. Non-limiting examples of cells include side population (SP) cells, lineage negative (Lin⁻) cells including Lin⁻ CD34⁻, Lin⁻CD34⁺, Lin⁻cKit⁺, mesenchymal stem cells including mesenchymal stem cells with 5-aza, cord blood cells, cardiac or other tissue derived stem cells, whole bone marrow, bone marrow mononuclear cells, endothelial progenitor cells, skeletal myoblasts or satellite cells, muscle derived cells, go cells, endothelial cells, adult cardiomyocytes, fibroblasts, smooth muscle cells, adult cardiac fibroblasts+5-aza, genetically modified cells, tissue engineered grafts, MyoD scar fibroblasts, pacing cells, embryonic stem cell clones, embryonic stem cells, fetal or neonatal cells, immunologically masked cells, and teratoma derived cells.

The drug agents useful in accordance with the present invention may be used singly or in combination. For example, an anti-proliferative agent such as paclitaxel may be used in combination with another drug agent, such as an anticoagulant, anti-inflammatory, antithrombogenic, thrombolytic, nitric oxide-containing polymer, or a vascular cell promoter such as VEGF, for example. As used herein, paclitaxel includes the alkaloid and any pharmacologically active derivative or analog thereof. Thus paclitaxel includes naturally occurring forms and derivatives thereof and synthetic and semi-synthetic forms thereof.

Various polymers may be used with the present invention. Polymers may be selected such that they are insoluble in the inert additive according to the invention. The polymers of the polymeric coatings may be biodegradable or non-biodegradable. Non-limiting examples of suitable non-biodegradable polymers include polystrene; polystyrene maleic anhydride; polyisobutylene copolymers such as styrene-isobutylene-styrene block copolymers (SIBS) and styrene-ethylene/butylene-styrene (SEBS) block copolymers; polyvinylpyrrolidone including cross-linked polyvinylpyrrolidone; polyvinyl alcohols, copolymers of vinyl monomers such as EVA; polyvinyl ethers; polyvinyl aromatics; polyethylene oxides; polyesters including polyethylene terephthalate; polyamides; polyacrylamides including poly(methylmethacrylate-butylacetate-methylmethacrylate) block copolymers; polyethers including polyether sulfone; polyalkylenes including polypropylene, polyethylene and high molecular weight polyethylene; polyurethanes; polycarbonates, silicones; siloxane polymers; cellulosic polymers such as cellulose acetate; polymer dispersions such as polyurethane dispersions (BAYHYDROL®); squalene emulsions; and mixtures and copolymers of any of the foregoing.

Non-limiting examples of suitable biodegradable polymers include polycarboxylic acid, polyanhydrides including maleic anhydride polymers; polyorthoesters; poly-amino acids; polyethylene oxide; polyphosphazenes; polylactic acid, polyglycolic acid and copolymers and mixtures thereof such as poly(L-lactic acid) (PLLA), poly(D,L-lactide), poly(lactic acid-co-glycolic acid), 50/50 (DL-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and blends; polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid; cellulose, and hydroxypropylmethyl cellulose; gelatin; starches; dextrans; alginates and derivatives thereof), proteins and polypeptides; and mixtures and copolymers of any of the foregoing. The biodegradable polymer may also be a surface erodable polymer such as polyhydroxybutyrate and its copolymers, polycaprolactone, polyanhydrides (both crystalline and amorphous), maleic anhydride copolymers, and zinc-calcium phosphate.

Various layers of coating may be applied to the body of a medical device according to the present invention. Similarly, some embodiments may include a polymer layer containing no therapeutic agent. The inert additive may be used in such a layer as described with respect to the therapeutic agent-containing layers, to create pores through the polymer. This may allow therapeutic agent disposed in a lower layer to elute through the top layer as well as the layer in which it is disposed.

A medical device according to the invention may also contain a radio-opacifying agent within its structure to facilitate viewing the medical device during insertion and at any point while the device is implanted. Non-limiting examples of radio-opacifying agents are bismuth subcarbonate, bismuth oxychloride, bismuth trioxide, barium sulfate, tungsten, and mixtures thereof.

Non-limiting examples of medical devices according to the present invention include catheters, guide wires, balloons, filters (e.g., vena cava filters), stents, stent grafts, vascular grafts, intraluminal paving systems, pacemakers, electrodes, leads, defibrillators, joint and bone implants, spinal implants, access ports, intra-aortic balloon pumps, heart valves, sutures, artificial hearts, neurological stimulators, cochlear implants, retinal implants, and other devices that can be used in connection with therapeutic coatings. Such medical devices are implanted or otherwise used in body structures, cavities, or lumens such as the vasculature, gastrointestinal tract, abdomen, peritoneum, airways, esophagus, trachea, colon, rectum, biliary tract, urinary tract, prostate, brain, spine, lung, liver, heart, skeletal muscle, kidney, bladder, intestines, stomach, pancreas, ovary, uterus, cartilage, eye, bone, joints, and the like.

The foregoing description and examples have been set forth merely to illustrate the invention and are not intended as being limiting. Each of the disclosed aspects and embodiments may be considered individually or in combination with other aspects, embodiments, and variations of the invention. Further, while certain features of embodiments of the present invention may be shown in only certain figures, such features can be incorporated into other embodiments shown in other figures while remaining within the scope of the present invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Furthermore, all references cited herein are incorporated by reference in their entirety.

What is claimed is:

1. A method of manufacturing a medical device having a porous coating comprising:
depositing on a body of a medical device an inert additive, a therapeutic agent insoluble in the inert additive, and a polymer insoluble in the inert additive; and
drying the body to remove the inert additive, wherein pores are formed in the polymer in the regions of the removed inert additive.

2. The method of claim 1, wherein the inert additive is water.

3. The method of claim 2, wherein the therapeutic agent is paclitaxel.

4. The method of claim 2, wherein the polymer is poly(styrene-b-isobutylene-b-styrene).

5. The method of claim 1, wherein the inert additive is an organic liquid.

6. The method of claim 1, wherein depositing comprises:
applying a mixture of the polymer, the therapeutic agent, and the inert additive to the body of the medical device.

7. The method of claim 1, wherein the depositing comprises:
applying a first mixture comprising the polymer, a first solvent, and the inert additive to the body of the medical device; and
applying a second mixture comprising a therapeutic agent and a second solvent to the body of the medical device.

8. The method of claim 1, wherein the depositing comprises:
applying a first mixture comprising the polymer and a first solvent to the body of the medical device; and
applying a second mixture comprising the therapeutic agent, a second solvent, and the inert additive to the body of the medical device.

9. The method of claim 1, wherein the depositing comprises:
applying a first mixture comprising the polymer, a first solvent, and the inert additive to the body of the medical device; and
applying a second mixture comprising the therapeutic agent, a second solvent, and the inert additive to the body of the medical device.

10. The method of claim 1, wherein the depositing comprises:
applying a mixture comprising the polymer and the therapeutic agent to the body of the medical device; and
applying the inert additive to the body of the medical device.

11. The method of claim 10, wherein applying the inert additive comprises spraying the inert additive onto the body of the medical device.

12. The method of claim 1, wherein drying the body of the medical device comprising heating the body of the medical device to a temperature above the boiling point of the inert additive.

13. The method of claim 1, wherein the medical device is a stent.

14. A method of manufacturing a porous coating comprising:
forming a coating comprising an inert additive, a therapeutic agent insoluble in the inert additive, and a polymer insoluble in the inert additive; and
drying the coating to remove the inert additive, wherein pores are formed in the coating in the regions of the removed inert additive.

15. A method of manufacturing a medical device having a porous coating comprising:
depositing on a body of a medical device an inert additive, a therapeutic agent insoluble in the inert additive, and a polymer insoluble in the inert additive;
applying a magnetic field to remove the inert additive, wherein pores are formed in the polymer in the regions of the removed inert additive.

16. A method of manufacturing a medical device having a porous coating comprising:
depositing on a body of a medical device a therapeutic agent insoluble in water, a polymer insoluble in water, and water; and
drying the body to remove the water, wherein pores are formed in the polymer in the regions of the removed water.
